(19) United States
(12) Patent Application Publication
(10) Pub. No.: US 2018/0099302 A1
(43) Pub. Date: Apr. 12, 2018

(54) ADJUSTABLE DROP NIPPLE FOR DRY PENDENT VALVE

(71) Applicant: Globe Fire Sprinkler Corporation, Standish, MI (US)

(72) Inventors: Stephen J. MEYER, Chester Springs, PA (US); Yoram RINGER, Providence, RI (US)

(21) Appl. No.: 15/290,224

(22) Filed: Oct. 11, 2016

(51) Int. Cl. B05B 15/08; A62C 35/68; B05B 15/06

(52) U.S. Cl. CPC B05B 15/08; B05B 15/068; A62C 35/68

(57) ABSTRACT

An adjustable drop nipple has an upper pipe with an inlet end adapted for connection to a branch pipe, and an outlet end. A lower pipe is telescopically and sealingly engaged with the upper pipe and has an inlet and an outlet including a connection for a sprinkler head. Upper and lower supports are respectively fixed to the upper and lower pipes. A vertical support member is positioned generally parallel to the longitudinal axes of the upper and lower pipes and is secured to the upper and lower supports by upper and lower fasteners, respectively. The upper fastener permits the vertical support member to travel axially upwardly upon an application of a primarily upward axial force, but prevents the vertical support member from traveling axially downwardly upon the application of a primarily downward axial force.

### BACKGROUND OF THE INVENTION

The present invention relates generally to fire protection, and more particularly to sprinkler systems for fire prevention and suppression.

A sprinkler system conventionally includes a water source connected to a plurality of sprinkler heads. In a sprinkler system installed in a room within a building, the water source is commonly connected to a system of water supply “branch pipes” that are run in the space near the ceiling of the room, or are run above a “drop” ceiling or suspended ceiling. The branch pipes are connected to individual sprinkler heads, which often must be offset vertically from the branch pipes in order to obtain an optimum position from which to spray water onto a fire. For example, where a drop ceiling is employed, the sprinkler heads must be offset from the branch pipes in order to be mounted at or below the level of the drop ceiling. The necessary offset is provided by connecting the sprinkler heads to the branch pipes using a length of piping or tubing that extends from a branch pipe to each sprinkler head.

The piping that extends from a branch pipe from a sprinkler head is commonly called a “drop nipple.” In simplest form, a drop nipple is simply a length of pipe. A drop nipple commonly is threaded at the upper end to connect to a T-joint or other joint in a branch pipe; the drop nipple commonly is also threaded at the lower end to permit attachment of a sprinkler head. When the drop nipple and sprinkler head are installed as part of a sprinkler system, the length of the drop nipple determines the final position (height) of the sprinkler head.

When sprinkler heads are installed in a building, the requirements for positioning the sprinkler heads are generally precise because the sprinkler head must be mounted in the proper position with respect to the branch pipe, drop ceilings, and other building components that influence optimal sprinkler head placement. In positioning a sprinkler head connected to a branch pipe by a drop nipple, installers adjust the final position (height) of the sprinkler head by adjusting the length of the drop nipple as described below.

The process of installing sprinkler systems is generally time-consuming and expensive. For example, consider this common sequence for installing a conventional sprinkler system in a room in a multi-story office building with drop ceilings:

First, horizontal branch pipes, which connect to a water source, are installed at the top of the room just below the bottom of the floor or floor support above the room. Then the drop nipples are installed at T-joints in the branch pipes, with each drop nipple extending vertically downwardly. The bottom of each drop nipple is sealed with a removable plug, and the sprinkler system is filled with water and tested for leaks.

Once it is determined that there are no leaks, the drop ceiling is installed. Holes are cut in the drop ceiling to allow the drop nipples to be accessed from below the drop ceiling. The length of a drop nipple is only slightly adjustable, a couple of inches, so the drop nipples must be made to order or cut on site to the size of the gap between the branch pipe and the planned position of the drop ceiling. After the drop ceiling is installed, the bottom of each drop nipple extends a few inches below the drop ceiling.

At this point the sprinkler heads are ready to be installed. The sprinkler system is drained, but water remains in the drop nipples. To drain the water, the plug is removed from the bottom of each drop nipple, and the water is drained from the drop nipple into a bucket. The installer then attempts to adjust the length of the drop nipple to the location (height) where the drop ceiling has been installed, which may not precisely match the location expected when the drop nipple was initially installed. If the drop nipple can be adjusted to the right length for the drop ceiling, the sprinkler is attached to the drop nipple. If the drop nipple is not the right length and cannot be adjusted to the right length the drop nipple must be removed from the T-joint. The necessary length may be measured and a replacement drop nipple may be ordered, or the drop nipple may be cut and re-threaded on site. Reordering or re-cutting requires time and incurs cost; and in either case, the replacement or re-cut drop nipple must be reinstalled into the T-joint, often with the drop ceiling obscuring the installer's vision. Thus the installation of a sprinkler system using conventional drop nipples often proves difficult, slow, and costly.

With this background, we describe below a new adjustable drop nipple, which uses a different adjustment mechanism from those employed in conventional drop nipples.

### BRIEF SUMMARY OF THE INVENTION

Briefly stated, a preferred embodiment of the preferred embodiment is directed to an adjustable drop nipple having an upper pipe. The upper pipe has an inlet end for connection to a branch pipe, an outlet end, and a longitudinal axis. A lower pipe is telescopically and sealingly engaged with the upper pipe. The lower pipe has an inlet, an outlet including a connection for sealing and supportive engagement of a sprinkler head, and a longitudinal axis. An upper support is fixed to the upper pipe. A lower support is fixed to the lower pipe. A vertical support member is positioned generally parallel to the longitudinal axes of the upper pipe and the lower pipe. An upper fastener secures the vertical support member to the upper support. A lower fastener secures the vertical support member to the lower pipe. The upper fastener permits the vertical support member to travel axially upwardly upon an application of a primarily upward axial force, but the upper fastener prevents the vertical support member from traveling axially downwardly upon the application of a primarily downward axial force.

In another aspect, a preferred embodiment of the invention is directed to a method for installing a sprinkler head. The method includes providing an adjustable drop nipple as described above; connecting the inlet end of the upper pipe of the adjustable drop nipple to a branch pipe of a fire sprinkler system; applying a primarily upward axial force to the vertical support member to set the length of the adjustable drop nipple so that the sprinkler head is located near a predetermined first vertical position; and rotating the vertical support member with respect to the upper fastener to move the lower pipe to the predetermined first vertical position.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side elevational sectional view of an adjustable drop nipple according to a preferred embodiment of the present invention;

FIG. 2 is a side elevational partial sectional view of an adjustable drop nipple of the present invention in the installation environment, connected to a branch pipe and passing through a drop ceiling; and

FIG. 3 is an enlarged partial perspective view of an upper support and a push nut of an adjustable drop nipple according to the present invention.

### DETAILED DESCRIPTION OF THE INVENTION

Certain terminology is used in the following description for convenience only and is not limiting. The words “lower,” “bottom,” “upper,” “top,” “front,” “back,” and “rear” designate directions in the drawings to which reference is made. The words “inwardly” and “outwardly” refer to directions toward and away from, respectively, the geometric center of the component being discussed, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

Throughout this application, the phrase “application of a primarily upward axial force” means applying an essentially linear force along the longitudinal axis of a member, resulting in a net positive generally upward force component along the longitudinal axis of the member. “Application of a primarily upward axial force” includes directly or indirectly pushing or pulling the member in a generally upward direction along the longitudinal axis thereof with sufficient force to overcome any downward forces, including the weight of connected components, carried by the member, so that the member moves in an upward direction along the longitudinal axis. “Application of a primarily upward axial force” does not include applying a torque to rotate the member and thereby causing an axial movement of the member through the interaction of threads on the member with another component of the device. Similarly, the phrase “application of a primarily downward axial force” means applying an essentially linear force along the longitudinal axis of a member, resulting in a net downward component along the longitudinal axis of the member. “Application of a primarily downward axial force” includes directly or indirectly pushing or pulling the member in a generally downward direction along the longitudinal axis thereof, or applying an upward force that is sufficiently small that there is still a net generally downward force component along the longitudinal axis of the member. For example, “application of a primarily downward axial force” occurs with respect to a vertical support member in an adjustable drop nipple according to the invention when the adjustable drop nipple is assembled the combined weight of the lower support and the lower pipe applies a primarily downward axial force to the vertical support member. “Application of a primarily downward axial force” to a member does not include applying a torque to rotate the member and thereby causing an axial movement of the member through the interaction of threads on the member with another component of the device.

Throughout this application, the phrase “threaded rod” means a rod that is threaded along at least a portion of the length of the rod.

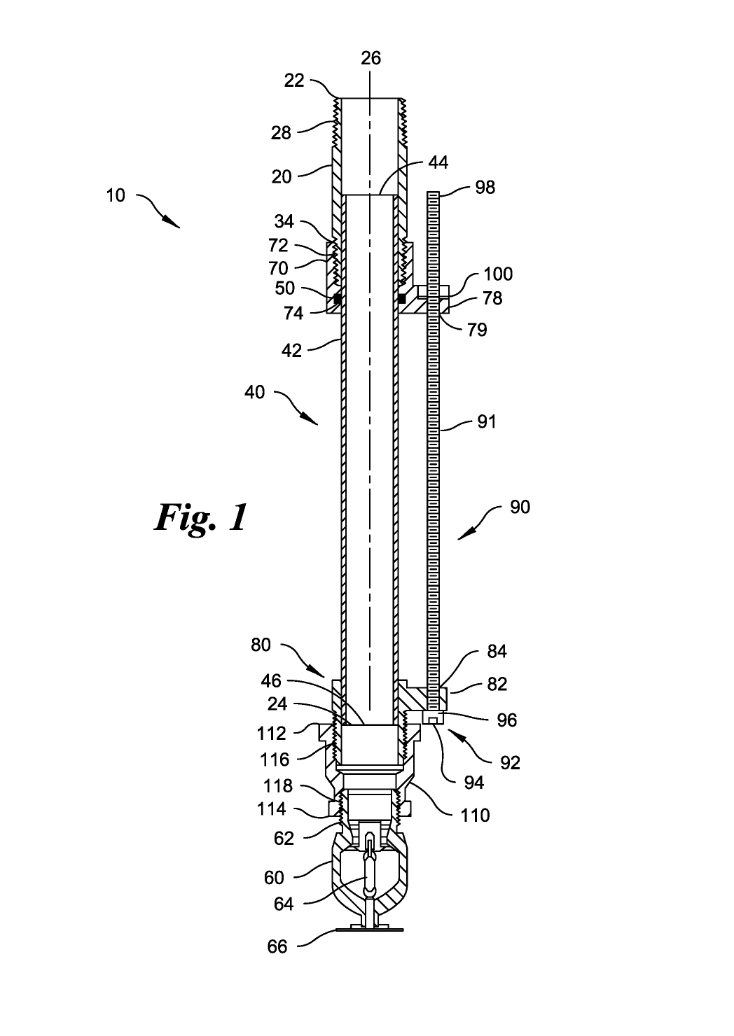

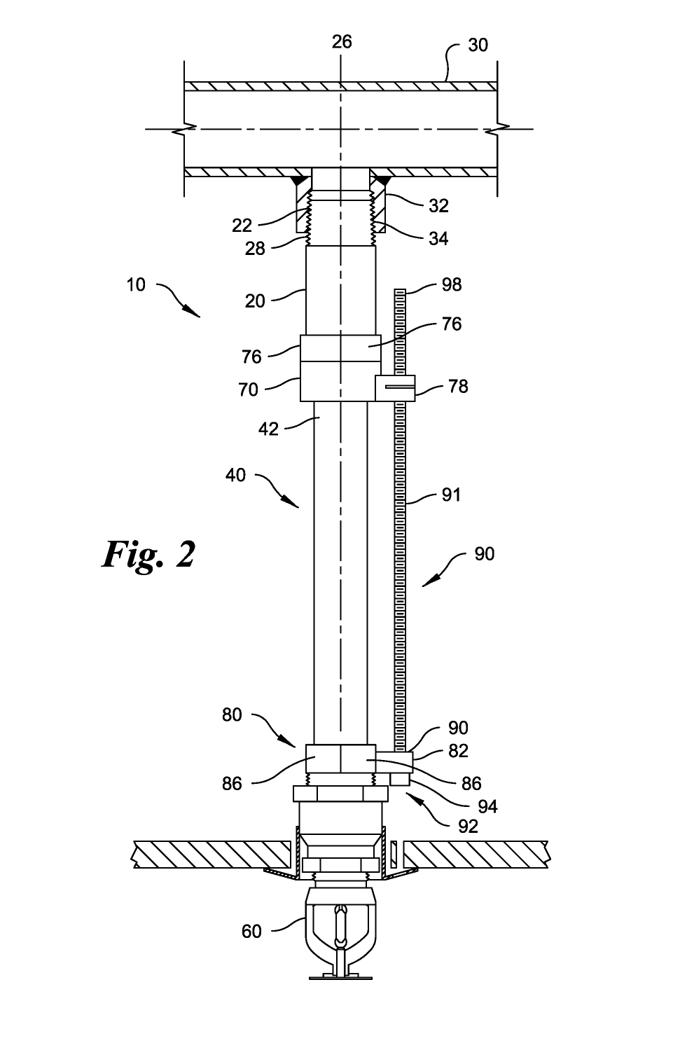

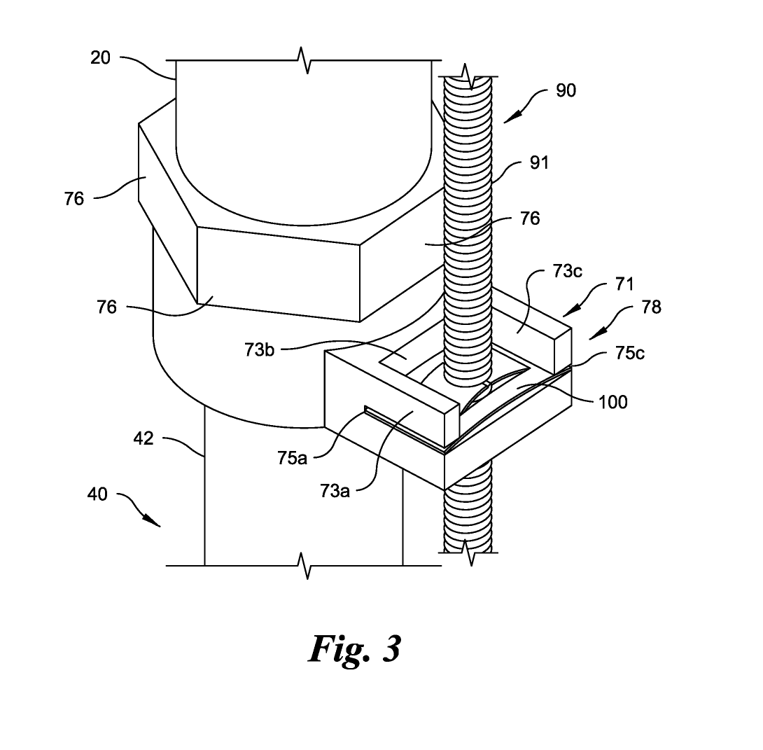

Referring to the drawings in detail, wherein like numerals indicate like elements throughout, FIGS. 1-3 show a preferred embodiment of an adjustable drop nipple, generally indicated at 10. The adjustable drop nipple has an upper pipe 20. The upper pipe 20 has an inlet end 22 for connection to a branch pipe 30 (see FIG. 2), an outlet end 24, and a longitudinal axis 26. The upper pipe 20 preferably has external threads 28 to adapt the upper pipe 20 for connection to the branch pipe 30 through the “Tee” 32, which has corresponding internal threads 32. Any suitable connection mechanism may be used, including grooves or internal threads (in which case the branch pipe 30 would have external threads), provided that the connection mechanism allows a water-tight connection to the branch pipe 30.

A lower pipe 40 is telescopically and sealingly engaged with the upper pipe 20. In the embodiment shown in FIGS. 1-3, the lower pipe 40 and the upper pipe 20 are engaged so that the upper pipe 20 is external to the lower pipe 40. Although this arrangement is more convenient and effective than the alternative arrangement, which would be to place the upper pipe inside the lower pipe, the alternative arrangement is within the scope of the invention. As seen in FIG. 1, the sealing engagement between the upper pipe 20 and the lower pipe 40 is preferably provided by an O-ring 50, which contacts an outer surface 42 of the lower pipe 40. The lower pipe 40 has an inlet 44, an outlet 46, and a longitudinal axis 26, which in the illustrated embodiment is shared with the upper pipe 20, due to the telescopic relationship between the upper pipe 20 and the lower pipe 40. At the outlet 46 of the lower pipe 40 is a connection for sealing and supportive engagement of a sprinkler head 60. The sprinkler head 60 is shown with external threads 62, a thermally responsive element 64 for triggering water flow, and a deflector 66. The particular form of the sprinkler head 60 is illustrative, and the adjustable drop nipple 10 according to the invention may be connected to sprinkler heads with and without external threads 62, a thermally responsive element 64, or a deflector 66.

An upper support in the form of an upper collar 70 encircles and is secured to the outer surface of the upper pipe 20. The upper collar 70 may be secured, for example, by internal threads 72 of the upper collar 70, by other mechanical fasteners such as grooves, or by an adhesive, or the upper collar 70 may be formed integrally with the upper pipe 20. The upper support need not be a collar 70 and may instead be a partial collar or other shape. In the illustrated embodiment, the upper collar 70 encircles and is supported by the outer surface of the upper pipe 20. The upper collar 70 is fixed to the upper pipe 20 by means of internal threads 72, which engage external threads 34 of the upper pipe 20. The upper collar 70 includes a channel 74, which houses the O-ring 50. The upper collar 70 has bearing surfaces 76 for engagement of a wrench or other tool for use in loosening, tightening, or holding the upper collar 70.

A lower support in the form of a lower collar 80 is fixed to the lower pipe 40. The lower collar 80 is secured to the outer surface 42 of the lower pipe 40. The lower support need not be a collar 80 and could instead be a partial collar or other shape. The lower collar 80 may be secured to the lower pipe 40 via a threaded connection, by other mechanical fasteners such as grooves, by welding, or by an adhesive, or the lower collar 80 may be formed integrally with the lower pipe 40.

A vertical support member includes a threaded rod 90 with a proximal end 92 and a screw head 94 near the proximal end 92. “Screw head” is used throughout this application to mean a head with a fitting, located near the proximal end 92 of the threated rod 90, for a screw driver, a nut driver, an Allen wrench, or another device for exerting a torque on the threaded rod 90. The screw head 94 forms a shoulder 96 with the proximal end 92 of the threaded rod 90. The threaded rod 90 is positioned generally parallel to the longitudinal axis 26 of the upper pipe 20 and the lower pipe 40. In a preferred embodiment, the threaded rod 90 has an essentially circular cross-section and self-locking threads.

An upper fastener in the form of an upper projection 78 from the upper collar 70 is oriented transversely to the axis 26 of the upper pipe 20 and the lower pipe 40. The upper projection 78 secures the threaded rod 90 to the upper collar 70. The upper projection 78 has a housing 71 formed by three walls 73a, 73b, and 73c. Two walls 73a and 73c include slots 75a and 75c, which accommodate a push nut 100. The upper projection 78 has an aperture 79, which is shown in FIG. 1.

A lower fastener in the form of a lower projection 82 is oriented transversely to the axis 26 of the upper pipe 20 and the lower pipe 40 and is fixed to the lower pipe 40 by the lower collar 80. The lower projection 82 secures the threaded rod 90 to the lower pipe 40. The lower projection 82 has a lower aperture 84, which is generally parallel to the longitudinal axis 26 of the upper pipe 20 and the lower pipe 40. The lower collar 80 has bearing surfaces 86 for engagement of a wrench or other tool for use in loosening, tightening, or holding the lower collar 80.

The push nut 100 in the upper projection 78 permits the threaded rod 90 to travel axially upwardly upon an application of a primarily upward axial force to the threaded rod 90 by allowing the threads of the threaded rod 90 to pass therethrough; but the push nut 100 prevents the threaded rod 90 from traveling axially downwardly upon the application of a primarily downward axial force by locking to prohibit downward motion of the threaded rod 90. The application of a primarily upward axial force to the threaded rod 90 preferably is accomplished by a user pushing upwardly by hand or with a tool upon the threaded rod 90 and the lower collar 80.

The push nut 100 in the upper projection 78, the lower projection 82, and the threaded rod 90 together act to fix a relative vertical position of the lower pipe 40 with respect to the upper pipe 20. The threaded rod 90 has a proximal end 92 and a distal end 98 and a stop, which is a shoulder 96, located near the proximal end 92. The distal end 98 of the threaded rod 90 slides through the aperture 84 in the upward direction until the shoulder 96 makes contact with the lower projection 82. The distal end 98 of the threaded rod 90 engages the push nut 100 in the upper projection 78.

The threaded rod 90 may be moved axially, either upwardly or downwardly with respect to the upper pipe 20, by rotating the threaded rod 90 via the screw head 94. Although in the preferred embodiment the upper fastener comprises the illustrated push nut 100, the upper fastener may include other styles of push nuts, or other devices such as ratchets or cams meeting the stated criteria of permitting axial upward motion upon application of a primarily upward axial force to the vertical support member and preventing axial downward motion upon application of a primarily downward axial force to the vertical support member.

In a preferred embodiment, the adjustable drop nipple 10 includes a coupler 110 with an inlet end 112 and an outlet end 114. The coupler 110 is sealingly engaged via internal threads 116 at the inlet end 112 to the lower collar 80. The coupler 110 is sealingly engaged via internal threads 118 at the outlet end 114 to the sprinkler head 60.

In another aspect, a preferred embodiment of the invention is directed to a method for installing a sprinkler head 60. The method includes providing an adjustable drop nipple 10 as described above; connecting the inlet end 22 of the upper pipe 20 of the adjustable drop nipple 10 to a branch pipe 30 of a fire sprinkler system; applying a primarily upward axial force to the threaded rod 90 to set the length of the adjustable drop nipple 10 so that the sprinkler head 60 is located near a predetermined first vertical position; and rotating the threaded rod 90 with respect to the push nut 100 in the upper projection 78 by means of the screw head 94 to adjust the first vertical position of the sprinkler head 60 to move the lower pipe 40 to the predetermined first vertical position.

In another aspect, a preferred embodiment of the invention is directed to a method of installing a sprinkler head 60. By this method, using an adjustable drop nipple 10 as described above, a sprinkler head 60 may be placed in a first vertical position, which may be the desired final position, as follows. First, an adjustable drop nipple 10 is provided in a state of partial assembly, with the threaded rod 90 not yet engaged with the push nut 100. The upper pipe 20 is threadedly engaged with a Tee 32 in a branch pipe 30. The lower pipe 40 is telescopically and sealingly engaged with the upper pipe 20, and the lower collar 80 is rotated so that the aperture 84 of the lower collar 80 is axially aligned with the push nut 100. The distal end 98 of the threaded rod 90 is then passed upwardly through the aperture 84 until the distal end 98 of the threaded rod 90 engages the push nut 100. The proximal end 92 of the threaded rod 90 is then pushed upwardly until the lower collar 80 is in a vertical position near the first vertical position; in this step, the threaded rod 90 travels axially upwardly without substantial rotation through the push nut 100. The threaded rod 90 may then be more finely adjusted to the first vertical position (as opposed to the initial placement “near” the first vertical position) by rotating the threaded rod 90 by means of the screw head 94.

The devices and components described herein may be made of steel or other metal, plastic (for example, PVC), or other materials of sufficient strength, heat resistance, corrosion resistance, and other properties to support operation of the devices and components as described herein. Suitable materials are known in the art. As noted previously, because the devices and components are intended for use in fire safety sprinkler systems, the devices and components must made to comply with applicable laws and regulations in order to be legal for use in many of their intended applications.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. An adjustable drop nipple comprising:
an upper pipe having an inlet end for connection to a branch pipe, an outlet end, and a longitudinal axis;
a lower pipe telescopically and sealingly engaged with the upper pipe, the lower pipe having an inlet, an outlet including a connection for sealing and supportive engagement of a sprinkler head, and a longitudinal axis;
an upper support fixed to the upper pipe;
a lower support fixed to the lower pipe;
a vertical support member positioned generally parallel to the longitudinal axes of the upper pipe and the lower pipe;
an upper fastener securing the vertical support member to the upper support; and
a lower fastener securing the vertical support member to the lower pipe;
the upper fastener permitting the vertical support member to travel axially upwardly upon an application of a primarily upward axial force but preventing the vertical support member from traveling axially downwardly upon the application of a primarily downward axial force.

2. The adjustable drop nipple of claim 1, wherein the lower pipe and the upper pipe are engaged with the upper pipe positioned external to the lower pipe.

3. The adjustable drop nipple of claim 1, wherein the upper fastener, the lower fastener, and the vertical support member together act to fix a relative vertical position of the lower pipe with respect to the upper pipe.

4. The adjustable drop nipple of claim 1, wherein the vertical support member is a threaded rod.

5. The adjustable drop nipple of claim 1, wherein the upper fastener comprises a push nut supported by the upper support.

6. The adjustable drop nipple of claim 1, wherein the upper support is an upper collar secured to the outer surface of the upper pipe and the lower support is a lower collar secured to the outer surface of the lower pipe.

7. The adjustable drop nipple of claim 1, wherein
the upper support comprises a collar encircling and supported by the outer surface of the upper pipe, and the upper fastener comprises an upper projection oriented transversely to the axis of the upper pipe and the lower pipe; and
the lower fastener comprises a lower projection oriented transversely to the axis of the upper pipe and lower pipe, the lower projection having a lower aperture generally parallel to the longitudinal axes of the upper pipe and the lower pipe;
wherein the vertical support member has a proximal end and a distal end and a stop located near the proximal end, so that the distal end of the vertical support member slides through the aperture in the upward direction until the stop makes contact with the lower projection, and the distal end of the vertical support member engages the upper fastener such that the vertical support member travels axially upwardly through the upper fastener upon an application of a primarily upward axial force but cannot travel axially downwardly upon an application of a primarily downward axial force.

8. The adjustable drop nipple of claim 7, wherein the vertical support member comprises a threaded rod having a screw head near the proximal end thereof, and the upper fastener comprises a push nut supported by the upper support and engaging the threads of the threaded rod such that the threaded rod travels axially upwardly through the push nut upon an application of an axial upward force but cannot travel axially downwardly upon an application of a primarily downward axial force, and wherein the threaded rod may be moved axially with respect to the upper pipe by rotating the threaded rod.

9. The adjustable drop nipple of claim 1, further comprising a coupler having an inlet end and an outlet end, and sealingly engaged at the inlet end to the lower collar and at the outlet end to the sprinkler head.

10. A method for installing a sprinkler head, comprising the steps of:
(a) providing an adjustable drop nipple comprising:
an upper pipe having an inlet end for connection to a branch pipe, an outlet end, and a longitudinal axis;
a lower pipe telescopically and sealingly engaged with the upper pipe, the lower pipe having an inlet, an outlet including a connection for sealing and supportive engagement of the sprinkler head, and a longitudinal axis;
an upper support fixed to the upper pipe;
a lower support fixed to the lower pipe;
a vertical support member generally parallel to the longitudinal axes of the upper pipe and the lower pipe;
a upper fastener securing the vertical support member to the upper support; and
a lower fastener securing the vertical support member to the lower pipe;
the upper fastener permitting the vertical support member to travel axially upwardly upon an application of a primarily upward axial force but preventing the vertical support member from traveling axially downwardly upon the application of a primarily downward axial force;
(b) connecting the inlet end of the upper pipe of the adjustable drop nipple to a branch pipe of a fire sprinkler system;
(c) applying a primarily upward axial force to the vertical support member to set the length of the adjustable drop nipple so that the sprinkler head is located near a predetermined first vertical position; and
(d) rotating the vertical support member with respect to the upper fastener to adjust the first vertical position of the sprinkler head to move the lower pipe to the predetermined first vertical position.

11. The method of claim 10, wherein in the provided adjustable drop nipple:
the vertical support member comprises a threaded rod with a proximal end, a distal end, and screw head near the proximal end;
the upper fastener comprises a push nut;
the adjustable drop nipple is provided in a state of partial assembly, with the threaded rod not yet engaged with the push nut;
the upper pipe is threadedly engaged with a Tee in a branch pipe;
the method further comprising the step of:
passing the distal end of the threaded rod upwardly through the lower fastener until the distal end of the threaded rod engages the push nut, and
wherein the applying step comprises pushing the proximal end of the threaded rod upwardly until the sprinkler head is in a vertical position near the first vertical position; and
wherein the rotating step comprises rotating the threaded rod by means of the screw head.
